(19) United States
(12) Patent Application Publication
(10) Pub. No.: US 2023/0299359 A1
(43) Pub. Date: Sep. 21, 2023

(54) ELECTROLYTE COMPOSITION FOR LITHIUM-ION CELLS WITH SILICON ELECTRODES

(71) Applicants: GM GLOBAL TECHNOLOGY OPERATIONS LLC, Detroit, MI (US); c/o Bar-Ilan University, RAMAT-GAN (IL)

(72) Inventors: Ion C. Halalay, Grosse Pointe Park, MI (US); Doron Aurbach, Bnei Brak (IL); Shalom Luski, Rehovot (IL); Michael P. Balogh, Novi, MI (US); Nicole Ellison, Madison Heights, MI (US); Jiazhi Hu, Troy, MI (US)

(73) Assignees: GM GLOBAL TECHNOLOGY OPERATIONS LLC, Detroit, MI (US); c/o Bar-Ilan University, RAMAT-GAN (IL)

(21) Appl. No.: 17/695,304

(22) Filed: Mar. 15, 2022

(51) Int. Cl. H01M 10/0569; H01M 10/0567; H01M 10/0568; H01M 10/0525; H01M 4/38

(52) U.S. Cl. CPC H01M 10/0569; H01M 4/386; H01M 10/0525; H01M 10/0567; H01M 10/0568; H01M 2004/027

(57) ABSTRACT

An electrolyte composition for use in a battery system including a silicon-based negative electrode having active material particles is provided. The electrolyte composition includes a polar solvent selected from the group consisting of ethylene carbonate, propylene carbonate, sulfolane, γ-butyrolactone, and combinations thereof and at least one lithium salt dissolved in the polar solvent at a concentration of at least 2 moles of the at least one lithium salt per 1 liter of the polar solvent. The at least one lithium salt and the polar solvent add dipoles to the electrolyte composition configured for reducing an electric field present at a surface of each of the active material particles in the silicon-based negative electrode of the battery system.

### INTRODUCTION

The disclosure generally relates to an electrolyte composition for lithium-ion cells with silicon electrodes.

A battery or battery system includes one or more battery cells. A lithium-ion cell or lithium-ion battery cell includes operation where, during a discharge cycle, lithium ions move from an anode to a cathode through an electrolyte composition. Lithium ions move in reverse, from the cathode to the anode, during a charging cycle. An electrolyte composition is configured for providing a medium through which the lithium ions may travel during battery operation.

### SUMMARY

An electrolyte composition for use in a battery system including a silicon-based negative electrode is provided. The electrolyte composition includes a polar solvent selected from the group consisting of ethylene carbonate, propylene carbonate, sulfolane, γ-butyrolactone, and combinations thereof and at least one lithium salt dissolved in the polar solvent at concentration of at least 2 moles of the at least one lithium salt per 1 liter of the polar solvent. The at least one lithium salt and the polar solvent add dipoles to the electrolyte composition that are configured for reducing an electric field present at a surface of each of the active material particles in the silicon-based negative electrode of the battery system.

In some embodiments, the at least one lithium salt is selected from the group consisting of LiPF₆, LiFSI, LiTFSI, LiBF₄, and combinations thereof.

In some embodiments, the electrolyte composition further includes a non-ionic surfactant present in from 0.1 parts by weight to 3.0 parts by weight based upon 100 parts by weight of the electrolyte composition.

In some embodiments, the non-ionic surfactant is selected from the group consisting of polyethylene glycol p-(1,1,3,3-tetramethylbutyl)-phenyl ether and poly(ethylene glycol)-block-poly(propylene glycol)-block-poly(ethylene glycol).

In some embodiments, the electrolyte composition further includes a solid electrolyte interphase forming additive selected from the group consisting of difluoroethylene carbonate, lithium difluorophosphate (LiPO₂F₂), and combinations thereof.

In some embodiments, the electrolyte composition further includes a thermally retardant copolar solvent selected from the group consisting of organic phosphates, phosphites, phosphonates, and combinations thereof.

In some embodiments, the at least one lithium salt is selected from the group consisting of LiPF₆, LiFSI, LiTFSI, LiBF₄, and combinations thereof. The electrolyte composition further includes a non-ionic surfactant. The electrolyte composition further includes a solid electrolyte interphase forming additive selected from the group consisting of difluoroethylene carbonate, lithium difluorophosphate (LiPO₂F₂), and combinations thereof. The electrolyte composition further includes a thermally retardant copolar solvent selected from the group consisting of organic phosphates, phosphites, phosphonates, and combinations thereof.

According to one alternative embodiment, an electrolyte composition for use in a battery system including a silicon-based negative electrode having active material particles is provided. The electrolyte composition includes a polar solvent including propylene carbonate present in at least 60 parts by weight based on 100 parts by weight of the polar solvent and at least one lithium salt dissolved in the polar solvent at a concentration of at least 2 moles of the at least one lithium salt per 1 liter of the polar solvent. The at least one lithium salt and the propylene carbonate add dipoles to the electrolyte composition that are configured for reducing an electric field present at a surface of each of the active material particles in the silicon-based negative electrode of the battery system.

In some embodiments, the polar solvent further includes dimethyl carbonate present in less than or equal to 30 parts by weight based on 100 parts by weight of the polar solvent.

In some embodiments, the polar solvent further includes fluoroethylene carbonate present in less than or equal to 10 parts by weight based on 100 parts by weight of the polar solvent.

In some embodiments, the polar solvent further includes difluoroethylene carbonate present in less than or equal to 5 parts by weight based on 100 parts by weight of the polar solvent.

In some embodiments, the electrolyte composition further includes a non-ionic surfactant present in from 0.1 parts by weight to 3.0 parts by weight based upon 100 parts by weight of the electrolyte composition.

In some embodiments, the at least one lithium salt is selected from the group consisting of LiPF₆, LiFSI, LiTFSI, LiBF₄, and combinations thereof.

In some embodiments, the at least one lithium salt is selected from the group consisting of LiPF₆, LiFSI, LiTFSI, LiBF₄, and combinations thereof. The polar solvent further includes dimethyl carbonate present in less than or equal to 30 parts by weight based on 100 parts by weight of the polar solvent. The polar solvent further includes fluoroethylene carbonate present in less than or equal to 10 parts by weight based on 100 parts by weight of the polar solvent. The electrolyte composition further includes a non-ionic surfactant.

In some embodiments, the at least one lithium salt is selected from the group consisting of LiPF₆, LiFSI, LiTFSI, LiBF₄, and combinations thereof. The polar solvent further includes dimethyl carbonate present in less than or equal to 30 parts by weight based on 100 parts by weight of the polar solvent. The polar solvent further includes difluoroethylene carbonate present in less than or equal to 5 parts by weight based on 100 parts by weight of the polar solvent. The electrolyte composition further includes a non-ionic surfactant present in from 0.1 parts by weight to 3.0 parts by weight based upon 100 parts by weight of the electrolyte composition.

According to one alternative embodiment, a device is provided. The device includes an output component and a battery configured for providing electrical energy to the output component. The battery includes a silicon-based negative electrode, a positive electrode, and an electrolyte composition disposed between the silicon-based negative electrode and the positive electrode. The electrolyte composition includes a polar solvent selected from the group consisting of propylene carbonate, sulfolane, γ-butyrolactone, and combinations thereof. The electrolyte composition further includes at least one lithium salt dissolved in the polar solvent at concentration of at least 2 moles of the at least one lithium salt per 1 liter of the polar solvent. The at least one lithium salt and the polar solvent add dipoles to the electrolyte composition configured for reducing an electric field present at a surface of each of the active material particles in the silicon-based negative electrode of the battery

In some embodiments, the electrolyte composition further includes a non-ionic surfactant.

In some embodiments, the electrolyte composition further includes a solid electrolyte interphase forming additive selected from the group consisting of difluoroethylene carbonate, lithium difluorophosphate (LiPO₂F₂), and combinations thereof.

In some embodiments, the electrolyte composition further includes a thermally retardant copolar solvent selected from the group consisting of organic phosphates, phosphites, phosphonates, and combinations thereof.

In some embodiments, the at least one lithium salt is selected from the group consisting of LiPF₆, LiFSI, LiTFSI, LiBF₄, and combinations thereof. The electrolyte composition further includes a non-ionic surfactant. The electrolyte composition further includes a solid electrolyte interphase forming additive selected from the group consisting of difluoroethylene carbonate, lithium difluorophosphate (LiPO₂F₂), and combinations thereof. The electrolyte composition further includes a thermally retardant copolar solvent selected from the group consisting of organic phosphates, phosphites, phosphonates, and combinations thereof.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery cell, including an anode, a cathode, a separator, and an electrolyte composition, in accordance with the present disclosure;

FIG. 2 schematically illustrates operation of a dipole in the presence of an electric field, in accordance with the present disclosure;

FIG. 3 is a graph illustrating specific capacity of a plurality of battery systems, each including different electrolyte compositions, through a battery system aging test, in accordance with the present disclosure; and

FIG. 4 schematically illustrates an exemplary device including a battery pack that includes a plurality of the battery cells of FIG. 1, in accordance with the present disclosure.

### DETAILED DESCRIPTION

During operation, a battery system consumes electroactive lithium and experiences surface film growth that is caused by an electric field created between a negatively charged anode and a positively charged cathode. Surface film growth and the deposition of lithium particles upon the electrodes may cause dendrite growth or the growth of finger-like projections that stand up from a surface of an electrode. An intense or relatively strong electric field at sharp edges and corners of silicon particles upon an electrode promotes dendrite growth during the structural rearrangements and large volume changes experienced by the silicon particles during lithium-ion cell operation. Dendrites increase a surface area which results in an acceleration of parasitic reactions with electrolyte solution consumption, leading to unintended surface film growth and gassing. These in turn may cause cell thickness increase and eventual cell inoperability and may magnify the possibility of thermal events due to abnormal cell operation or mechanical abuse.

An electrolyte solution may be defined as an electrolyte composition or a composition of components that make up the electrolyte solution. An electrolyte composition is provided for lithium-ion batteries with silicon-based anodes having active material particles. The electrolyte composition mitigates particle-to-dendrite transformation in silicon active material particles. The electrolyte composition minimizes surface film growth and gassing. The electrolyte composition minimizes a possibility of thermal events under abnormal operating conditions or mechanical abuse conditions.

The electrolyte composition includes a base formulation, including one or more lithium salts plus a polar solvent or mixture of polar solvents. A function of the base formulation is to enable lithium-ion transport between the electrodes. The electrolyte composition further includes an additive package which includes molecular compounds and/or salts. A function of the additive package is to form protective films on surfaces of the electrodes. These protective films prevent contact of anions and polar solvents with active materials of the anode and the cathode, as direct contact between these substances may cause thermodynamic instability in the battery system. The resulting electrolyte composition, including the base formulation and the additive package, may result in excellent lithium-ion conduction, electronic insulation between the electrodes, excellent wetting of the electrodes and the separator, chemical compatibility with other battery materials, and passivation of the surfaces of active materials in the electrodes. Additionally, the resulting electrolyte composition, including the base formulation and the additive package, may result in the included lithium salts exhibiting relatively easy dissociation in aprotic polar solvents and stability of anions against reduction at the anode and oxidation at the cathode. Additionally, the resulting electrolyte composition, including the base formulation and the additive package, may result in the included polar solvents exhibiting a relatively low melting point and relatively high boiling and flash points; exhibiting a relatively wide electrochemical stability window, a relatively low viscosity, a relatively low toxicity, and relatively high permittivity and dipole moments. Additionally, the electrolyte composition including the disclosed additives provides excellent decomposition potentials to form films on the electrodes, wherein the films provide or facilitate excellent lithium-ion conduction and excellent electronic insulation between the electrodes. Additionally, the resulting electrolyte composition including the additive package may match a surface tension of the electrolyte composition to the surface tension of materials in the separator of the battery system, as well as the surface tension of the composite anode and cathode.

The electrolyte composition may add dipoles to reduce or counteract the electric field created between the electrodes. The electrolyte composition may include a relatively highly concentrated electrolyte solution as compared to other electrolyte compositions. The electrolyte composition may include high dipole moment polar solvents. The electrolyte composition may include use of dipoles implemented by high concentrations of ion pairs and polar solvents without free polar solvent molecules to reduce the net electric field at particle edges and concerns of silicon particles. The electrolyte composition may include surfactants to improve the wetting of a separator and of the electrodes by the electrolyte composition. The electrolyte composition may include polar solvents with a relatively low vapor pressure and relatively high boiling point and flash points to avoid or prevent thermal events. The electrolyte composition may be thermally retardant or more thermally retardant as comparted to other electrolyte compositions. The electrolyte composition may include an addition of thermally retardant materials as additives.

The electrolyte composition may be relatively concentrated such that the polar solvent molecules are committed to the solvation sphere of lithium ions. The dipoles from the ion pairs operate to reduce an electric field around the silicon particles in the electrodes to impede the particle-to-dendrite transformation. The electric field may be further decreased by use of relatively highly polar solvents.

The electrolyte composition may include polar solvents with relatively low vapor pressure, as well as relatively high boiling and flash points, in conjunction with a surfactant, to match the surface tension of the electrolyte composition with that of a polymeric separator and thus improve the wetting of the separator and electrodes with the electrolyte composition. The surfactant may be present in an amount of from 0.1 part by weight to 3.0 parts by weight based upon 100 parts by weight of the electrolyte composition.

The disclosed electrolyte composition may include a salt concentration of at least 2.0 molar. That is, the electrolyte composition may include at least one lithium salt dissolved in a polar solvent at a concentration of at least 2 moles of the at least one lithium salt per 1 liter of the polar solvent. The disclosed electrolyte composition may include a lithium salt concentration of from 2.5 molar to 3.0 molar. The at least one lithium salt may include LiPF₆, LiFSI, LiTFSI, LiBF₄, and/or combinations thereof.

The disclosed electrolyte composition may include relatively highly polar solvents with high boiling and flash points, as well as a low vapor pressure. The polar solvent may be selected from the group consisting of propylene carbonate, sulfolane, γ-butyrolactone, and/or combinations of these polar solvents in various volume ratios.

The disclosed electrolyte composition may include one or more non-ionic surfactants. The surfactants may include Pluronic^{®} P123 (P123) (CAS # 9003-11-6), which is commercially available through the BASF Corporation of Florham Park, New Jersey, US, and is a triblock copolymer with the International Union of Pure and Applied Chemistry (IUPAC) name of poly(ethylene glycol)-block-poly(propylene glycol)-block-poly(ethylene glycol); Triton X-100^{®} (CAS # 9002-93-1), which is commercially available through the Union Carbide Corporation of North Seadrift, Texas, US and which may be described by the chemical name polyethylene glycol p-(1,1,3,3-tetramethylbutyl)-phenyl ether, IUPAC name 2-[4-(2,4,4-trimethylpentan-2-yl)phenoxy]ethanol; and/or combinations thereof. As described herein, use of one or more surfactants in the electrolyte composition may be used to match surface tension between the electrolyte composition and the separator and thereby improve wetting of the electrodes and the separator.

The disclosed electrolyte composition may include a solid electrolyte interface (SEI)-forming additive. The SEI-forming additive may include difluoroethylene carbonate (DFEC), LiPO₂F₂, and/or combinations thereof. Use of the SEI-forming additive(s) may be used to prevent undesired surface film growth on the silicon electrode and gassing due to parasitic reactions.

The disclosed composition may include thermally retardant copolar solvents. The thermally retardant copolar solvents may include organic phosphates, phosphites, phosphonates, and/or combinations thereof.

A lithium salt and a polar solvent may be selected for use in the disclosed electrolyte composition to optimize or enhance adding large amounts of dipoles to the electrolyte composition. These dipoles are useful for reducing the electric field present at a surface of each of the active material particles. An electrical dipole is an entity in which the negative charges and positive charges do not overlap perfectly (as, e.g., is the case in an atom, where the charge of the electrons’ cloud is perfectly offset by the charge of the protons in its nucleus). A dipole can be formed by a positive and negative ion (in which this is called an “ion pair”). It can also exist in asymmetric molecules, where the center gravity of the negative charge of the electrons cloud does not spatially coincide with the center of gravity of the positive charge in the sum of nuclei of the molecule. From a certain distance, the whole composition appears as electrically neutral, but close-up that is not the case.

One may utilize the disclosed electrolyte composition with a relatively large concentration of dipoles (either ion pairs and/or polar molecules) to decrease the driving force for a particle-to-dendrite transformation which occurs in silicon active materials particles during electrochemical cycling which occurs especially at an intense electric field that exists at the edges and corners of Si particles. The disclosed electrolyte composition includes relatively large concentrations of dipoles because the configuration of minimum potential energy of a dipole in an external electric field is with its own field (called a dipole moment) oriented in a direction counter-parallel to that of the applied field. As a result, a lithium ion moving from or towards a silicon particle will experience a reduced net electric, hence there will be less of a driving force for the particle-to-dendrites transformation.

An electrolyte composition for use in a battery system including a silicon-based negative electrode is provided. The electrolyte composition includes a polar solvent selected from the group consisting of ethylene carbonate, propylene carbonate, sulfolane, γ-butyrolactone, and combinations thereof and at least one lithium salt dissolved in the polar solvent at concentration of at least 2 moles of the at least one lithium salt per 1 liter of the polar solvent. The at least one lithium salt and the polar solvent add dipoles to the electrolyte composition that are configured for reducing an electric field present at a surface of each of the active material particles in the silicon-based negative electrode of the battery system.

The at least one lithium salt may be selected from the group consisting of LiPF₆, LiFSI, LiTFSI, LiBF₄, and combinations thereof.

The electrolyte composition may further include a non-ionic surfactant present in from 0.1 parts by weight to 3.0 parts by weight based upon 100 parts by weight of the electrolyte composition.

The non-ionic surfactant may be selected from the group consisting of polyethylene glycol p-(1,1,3,3-tetramethylbutyl)-phenyl ether and poly(ethylene glycol)-block-poly(propylene glycol)-block-poly(ethylene glycol).

The electrolyte composition may further include a solid electrolyte interphase forming additive selected from the group consisting of difluoroethylene carbonate, lithium difluorophosphate (LiPO₂F₂), and combinations thereof.

The electrolyte composition may further include a thermally retardant copolar solvent selected from the group consisting of organic phosphates, phosphites, phosphonates, and combinations thereof.

The at least one lithium salt is selected from the group consisting of LiPF₆, LiFSI, LiTFSI, LiBF₄, and combinations thereof. The electrolyte composition further comprises a non-ionic surfactant. The electrolyte composition further comprises a solid electrolyte interphase forming additive selected from the group consisting of difluoroethylene carbonate, lithium difluorophosphate (LiPO₂F₂), and combinations thereof. The electrolyte composition further comprises a thermally retardant copolar solvent selected from the group consisting of organic phosphates, phosphites, phosphonates, and combinations thereof.

According to one alternative embodiment, electrolyte composition for use in a battery system including a silicon-based negative electrode is provided. The electrolyte composition includes a polar solvent including propylene carbonate present in at least 60 parts by weight based on 100 parts by weight of the polar solvent and at least one lithium salt dissolved in the polar solvent at concentration of at least 2 moles of the at least one lithium salt per 1 liter of the polar solvent. The at least one lithium salt and the propylene carbonate add dipoles to the electrolyte composition that are configured for reducing an electric field present at a surface of each of the active material particles in the silicon-based negative electrode of the battery system.

The polar solvent may further include dimethyl carbonate present in less than or equal to 30 parts by weight based on 100 parts by weight of the polar solvent.

The polar solvent may further include fluoroethylene carbonate present in less than or equal to 10 parts by weight based on 100 parts by weight of the polar solvent.

The polar solvent may further include difluoroethylene carbonate present in less than or equal to 5 parts by weight based on 100 parts by weight of the polar solvent.

The electrolyte composition may further include a non-ionic surfactant present in from 0.1 parts by weight to 3.0 parts by weight based upon 100 parts by weight of the electrolyte composition.

The at least one lithium salt may be selected from the group consisting of LiPF₆, LiFSI, LiTFSI, LiBF₄, and combinations thereof.

The at least one lithium salt may be selected from the group consisting of LiPF₆, LiFSI, LiTFSI, LiBF₄, and combinations thereof. The polar solvent may further include dimethyl carbonate present in less than or equal to 30 parts by weight based on 100 parts by weight of the polar solvent. The polar solvent may further include fluoroethylene carbonate present in less than or equal to 10 parts by weight based on 100 parts by weight of the polar solvent. The electrolyte composition may further include a non-ionic surfactant.

The at least one lithium salt may be selected from the group consisting of LiPF₆, LiFSI, LiTFSI, LiBF₄, and combinations thereof. The polar solvent may further include dimethyl carbonate present in less than or equal to 30 parts by weight based on 100 parts by weight of the polar solvent. The polar solvent may further include difluoroethylene carbonate present in less than or equal to 5 parts by weight based on 100 parts by weight of the polar solvent. The electrolyte composition may further include a non-ionic surfactant present in from 0.1 parts by weight to 3.0 parts by weight based upon 100 parts by weight of the electrolyte composition.

According to one alternative embodiment, a device is provided. The device includes an output component and a battery configured for providing electrical energy to the output component. The battery includes a silicon-based negative electrode, a positive electrode, and an electrolyte composition disposed between the silicon-based negative electrode and the positive electrode. The electrolyte composition includes a polar solvent selected from the group consisting of propylene carbonate, sulfolane, γ-butyrolactone, and combinations thereof. The electrolyte composition further includes at least one lithium salt dissolved in the polar solvent at concentration of at least 2 moles of the at least one lithium salt per 1 liter of the polar solvent. The at least one lithium salt and the polar solvent add dipoles to the electrolyte composition configured for reducing an electric field present at a surface of each of the active material particles in the silicon-based negative electrode of the battery

The electrolyte composition may further include a non-ionic surfactant.

The electrolyte composition may further include a solid electrolyte interphase forming additive selected from the group consisting of difluoroethylene carbonate, lithium difluorophosphate (LiPO₂F₂), and combinations thereof.

The electrolyte composition may further include a thermally retardant copolar solvent selected from the group consisting of organic phosphates, phosphites, phosphonates, and combinations thereof.

The at least one lithium salt may be selected from the group consisting of LiPF₆, LiFSI, LiTFSI, LiBF₄, and combinations thereof. The electrolyte composition further includes a non-ionic surfactant. The electrolyte composition may further include a solid electrolyte interphase forming additive selected from the group consisting of difluoroethylene carbonate, lithium difluorophosphate (LiPO₂F₂), and combinations thereof. The electrolyte composition may further include a thermally retardant copolar solvent selected from the group consisting of organic phosphates, phosphites, phosphonates, and combinations thereof.

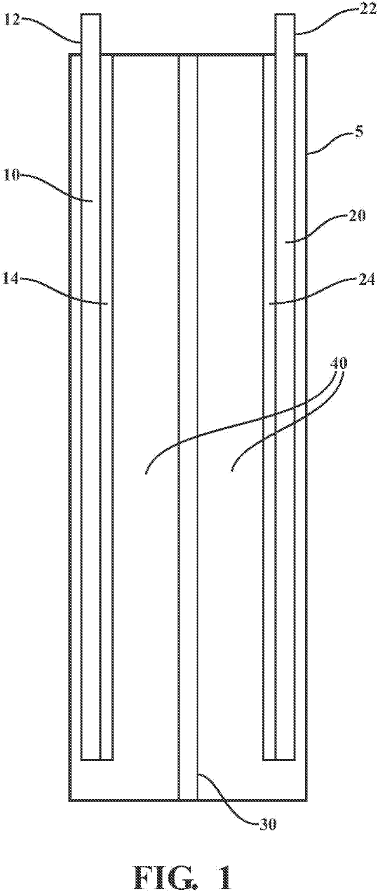

Referring now to the drawings, wherein like reference numbers refer to like features throughout the several views, FIG. 1 schematically illustrates an exemplary battery system 5, including an anode 10, a cathode 20, a separator 30, and the electrolyte composition 40. The battery system 5 enables converting electrical energy into stored chemical energy in a charging cycle, and the battery system 5 enables converting stored chemical energy into electrical energy in a discharging cycle. The anode 10 includes a first current collector 12. The cathode 20 includes a second current collector 22. The separator 30 is operable to separate the anode 10 from the cathode 20 and to enable ion transfer through the separator 30. The electrolyte composition 40 is a liquid and/or gel that provides a lithium-ion conduction path between the anode 10 and the cathode 20.

The anode 10 includes a coating 14. The coating 14 may be constructed of active material particles useful in an anode including silicon. The cathode 20 includes a coating 24. The coating 24 may be constructed of active material particles useful in a cathode.

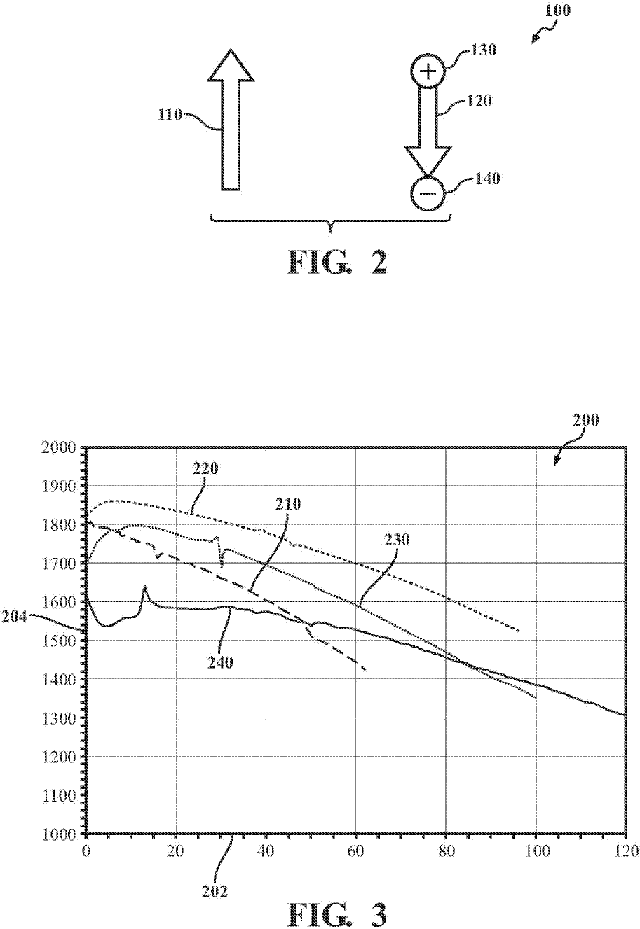

FIG. 2 schematically illustrates operation of a dipole 100 in the presence of an electric field 110. The electric field 110 may be created by two charged particles or plates, such as electrodes within the battery system 5 of FIG. 1. The illustrated arrowhead of the electric field 110 points to a negative pole of the electric field 110. The dipole 100 includes a positively charged particle 130 and a negatively charged particle 140. The dipole 100 exists as an ion pair within the electrolyte composition 40 of FIG. 1. Within the liquid or gel electrolyte composition 40, the positively charged particle 130 is attracted to the negative pole of the electric field 110, and the negatively charged particle 140 is attracted to the positive pole of the electric field 110. As a result of these attractions to the electric field, the positive particle 130, the negative particle 140, and a resulting dipole moment 120 between the positive particle 130 and the negative particle 140 align opposite to the polarity of the electric field 110. As a result, the dipole moment 120 acts to counteract or reduce an intensity of the electric field 110. In this way, use of the dipole 100 within the electrolyte composition 40 of FIG. 1 is useful to reduce an intensity of an electric field 110 within the battery system 5 of FIG. 1. More specifically, the at least one lithium salt and the polar solvent together add dipoles 100 to the electrolyte composition 40 that are configured for reducing the electric field 110 present at a surface of each of the active material particles.

FIG. 3 is a graph 200 illustrating specific capacity of a plurality battery systems, each including different electrolyte compositions, through a battery system aging test. A horizontal axis 202 illustrates a cycle index of the battery system aging test. A vertical axis 204 illustrates a specific capacity of each battery system. The plots 210, 220, 230, and 240 illustrate specific capacity loss or a specific capacity loss rate for each of the battery systems through the battery system aging test. The battery system aging test includes cycling the battery systems at a C/3 rate (one third of a total current capacity of the battery system) and with the battery system voltage being maintained between 2.75 V and 4.10 V. The plot 210 illustrates a battery system including an electrolyte composition of 1 M LiPF₆/fluoroethylene carbonate (FEC):dimethyl carbonate (DMC) 1:4. The plot 210 represents a baseline system provided for comparison to the plot 220, the plot 230, and the plot 240. The plot 220 illustrates a battery system including an electrolyte composition of 1 M LiPF₆/DMC:propylene carbonate (PC):FEC (3:6:1) + 2 % by weight LiPO₂F₂. The plot 230 illustrates a battery system including an electrolyte composition of 1 M LiPF6/DMC:PC:difluoroethylene carbonate (DFEC) (30:65:5) + 2 % by weight LiPO₂F₂. The plot 240 illustrates a battery system including an electrolyte composition of 1 M LiPF6/DMC:PC:DFEC (30:65:5) + 2 % by weight LiPO₂F₂+ a surfactant (P123). PC is provided as a polar solvent that provides a relatively large number of dipoles and additionally has a relatively low vapor pressure and relatively high boiling and flash points. FEC, DFEC, and LiPO₂F₂ are provided as polar solvents and a salt, respectively, that facilitate or enable formation of an excellent SEI upon the electrodes and prevent excessive surface film growth upon the electrodes and gassing.

The plot 220 and the plot 230 exhibit a positive slope at a far left side of the graph 200. These anomalous readings may be attributed to an artifact due to incomplete filling of pores upon the electrodes and the separator with the electrolyte composition at a beginning of the test. Analyzing the plot 210, the plot 220, the plot 230, and the plot 240, and particularly slops of the plots from left to right, one may see that plot 210 exhibits a highest long-term specific capacity loss (a highest slope). Plot 230 exhibits a next highest long-term specific capacity loss (a 2nd highest slope). Plot 220 exhibits a next highest long-term specific capacity loss (a 3rd highest slope). Plot 240 exhibits a lowest long-term specific capacity loss (a 4th highest slope). The battery system illustrated by plot 240 including the electrolyte composition including 1 M LiPF6/DMC:PC:DFEC (30:65:5) + 2 % by weight LiPO₂F₂ + a surfactant and the battery system illustrated by plot 220 including the electrolyte composition including the electrolyte composition including 1 M LiPF₆/DMC:PC:FEC (3:6:1) + 2 % by weight LiPO₂F performed the best at retaining specific capacity over the battery system aging test. Further, the electrolyte compositions illustrated by plot 220, plot 230, and plot 240 further include a benefit of a reduced proportion of DMC in each electrolyte composition and an addition of PC in each electrolyte composition, both of which reduce a likelihood of a thermal event when the cells are disassembled in air.

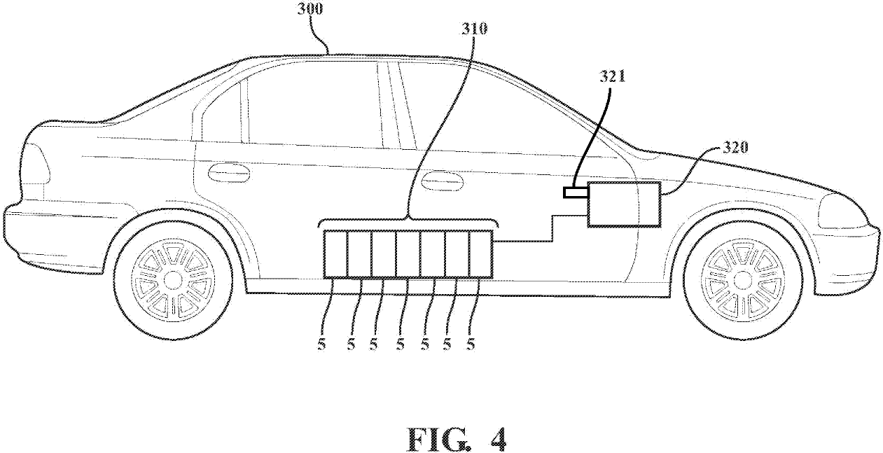

The battery system 5 may be utilized in a wide range of applications and powertrains. FIG. 4 schematically illustrates an exemplary device 200, e.g., a battery electric vehicle (BEV), including a battery pack 310 that includes a plurality of battery systems 5. The plurality of battery systems 5 may be connected in various combinations, for example, with a portion being connected in parallel and a portion being connected in series, to achieve goals of supplying electrical energy at a desired voltage. The battery pack 310 is illustrated as electrically connected to a motor generator unit 320 useful to provide motive force to the vehicle 300. The motor generator unit 320 may include an output component 321, for example, an output shaft, which provides mechanical energy useful to provide the motive force to the vehicle 300. A number of variations to vehicle 300 are envisioned, and the disclosure is not intended to be limited to the examples provided.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte composition for use in a battery system including a silicon-based negative electrode having active material particles, the electrolyte composition comprising:
a polar solvent selected from the group consisting of ethylene carbonate, propylene carbonate, sulfolane, γ-butyrolactone, and combinations thereof; and
at least one lithium salt dissolved in the polar solvent at a concentration of at least 2 moles of the at least one lithium salt per 1 liter of the polar solvent; and
wherein the at least one lithium salt and the polar solvent add dipoles to the electrolyte composition that are configured for reducing an electric field present at a surface of each of the active material particles in the silicon-based negative electrode of the battery system.

2. The electrolyte composition of claim 1, wherein the at least one lithium salt is selected from the group consisting of LiPF₆, LiFSI, LiTFSI, LiBF₄, and combinations thereof.

3. The electrolyte composition of claim 1, wherein the electrolyte composition further comprises a non-ionic surfactant present in an amount of from 0.1 part by weight to 3.0 parts by weight based upon 100 parts by weight of the electrolyte composition.

4. The electrolyte composition of claim 3, wherein the non-ionic surfactant is selected from the group consisting of polyethylene glycol p-(1,1,3,3-tetramethylbutyl)-phenyl ether and poly(ethylene glycol)-block-poly(propylene glycol)-block-poly(ethylene glycol).

5. The electrolyte composition of claim 1, wherein the electrolyte composition further comprises a solid electrolyte interphase forming additive selected from the group consisting of difluoroethylene carbonate, lithium difluorophosphate (LiPO₂F₂), and combinations thereof.

6. The electrolyte composition of claim 1, wherein the electrolyte composition further comprises a thermally retardant copolar solvent selected from the group consisting of organic phosphates, phosphites, phosphonates, and combinations thereof.

7. The electrolyte composition of claim 1, wherein the at least one lithium salt is selected from the group consisting of LiPF₆, LiFSI, LiTFSI, LiBF₄, and combinations thereof;
wherein the electrolyte composition further comprises a non-ionic surfactant;
wherein the electrolyte composition further comprises a solid electrolyte interphase forming additive selected from the group consisting of difluoroethylene carbonate, lithium difluorophosphate (LiPO₂F₂), and combinations thereof; and
wherein the electrolyte composition further comprises a thermally retardant copolar solvent selected from the group consisting of organic phosphates, phosphites, phosphonates, and combinations thereof.

8. An electrolyte composition for use in a battery system including a silicon-based negative electrode having active material particles, the electrolyte composition comprising:
a polar solvent including propylene carbonate present in at least 60 parts by weight based on 100 parts by weight of the polar solvent; and
at least one lithium salt dissolved in the polar solvent at a concentration of at least 2 moles of the at least one lithium salt per 1 liter of the polar solvent; and
wherein the at least one lithium salt and the propylene carbonate add dipoles to the electrolyte composition that are configured for reducing an electric field present at a surface of each of the active material particles in the silicon-based negative electrode of the battery system.

9. The electrolyte composition of claim 8, wherein the polar solvent further includes dimethyl carbonate present in an amount of less than or equal to 30 parts by weight based on 100 parts by weight of the polar solvent.

10. The electrolyte composition of claim 9, wherein the polar solvent further includes fluoroethylene carbonate present in an amount of less than or equal to 10 parts by weight based on 100 parts by weight of the polar solvent.

11. The electrolyte composition of claim 9, wherein the polar solvent further includes difluoroethylene carbonate present in an amount of less than or equal to 5 parts by weight based on 100 parts by weight of the polar solvent.

12. The electrolyte composition of claim 11, wherein the electrolyte composition further includes a non-ionic surfactant present in an amount of from 0.1 part by weight to 3.0 parts by weight based upon 100 parts by weight of the electrolyte composition.

13. The electrolyte composition of claim 8, wherein the at least one lithium salt is selected from the group consisting of LiPF₆, LiFSI, LiTFSI, LiBF₄, and combinations thereof.

14. The electrolyte composition of claim 8, wherein the at least one lithium salt is selected from the group consisting of LiPF₆, LiFSI, LiTFSI, LiBF₄, and combinations thereof;
wherein the polar solvent further includes dimethyl carbonate present in an amount of less than or equal to 30 parts by weight based on 100 parts by weight of the polar solvent;
wherein the polar solvent further includes fluoroethylene carbonate present in an amount of less than or equal to 10 parts by weight based on 100 parts by weight of the polar solvent; and
wherein the electrolyte composition further includes a non-ionic surfactant.

15. The electrolyte composition of claim 8, wherein the at least one lithium salt is selected from the group consisting of LiPF₆, LiFSI, LiTFSI, LiBF₄, and combinations thereof;
wherein the polar solvent further includes dimethyl carbonate present in an amount of less than or equal to 30 parts by weight based on 100 parts by weight of the polar solvent;
wherein the polar solvent further includes difluoroethylene carbonate present in an amount of less than or equal to 5 parts by weight based on 100 parts by weight of the polar solvent; and
wherein the electrolyte composition further includes a non-ionic surfactant present in an amount of from 0.1 part by weight to 3.0 parts by weight based upon 100 parts by weight of the electrolyte composition.

16. A device comprising:
an output component; and
a battery configured for providing electrical energy to the output component, the battery including:
a silicon-based negative electrode having active particles;
a positive electrode; and
an electrolyte composition disposed between the silicon-based negative electrode and the positive electrode, the electrolyte composition including:
a polar solvent selected from the group consisting of propylene carbonate, sulfolane, γ-butyrolactone, and combinations thereof; and
at least one lithium salt dissolved in the polar solvent at a concentration of at least 2 moles of the at least one lithium salt per 1 liter of the polar solvent; and
wherein the at least one lithium salt and the polar solvent add dipoles to the electrolyte composition configured for reducing an electric field present at a surface of each of the active material particles in the silicon-based negative electrode of the battery.

17. The device of claim 16, wherein the electrolyte composition further includes a non-ionic surfactant.

18. The device of claim 16, wherein the electrolyte composition further includes a solid electrolyte interphase forming additive selected from the group consisting of difluoroethylene carbonate, lithium difluorophosphate (LiPO₂F₂), and combinations thereof.

19. The device of claim 16, wherein the electrolyte composition further includes a thermally retardant copolar solvent selected from the group consisting of organic phosphates, phosphites, phosphonates, and combinations thereof.

20. The device of claim 16, wherein the at least one lithium salt is selected from the group consisting of LiPF₆, LiFSI, LiTFSI, LiBF₄, and combinations thereof;
wherein the electrolyte composition further includes a non-ionic surfactant;
wherein the electrolyte composition further includes a solid electrolyte interphase forming additive selected from the group consisting of difluoroethylene carbonate, lithium difluorophosphate (LiPO₂F₂), and combinations thereof; and
wherein the electrolyte composition further includes a thermally retardant copolar solvent selected from the group consisting of organic phosphates, phosphites, phosphonates, and combinations thereof.
